(19) United States
(12) Patent Application Publication
(10) Pub. No.: US 2006/0164031 A1
(43) Pub. Date: Jul. 27, 2006

(54) Battery pack equipped with detachable rechargeable battery and portable electronic device equipped with the battery pack

(76) Inventor: Sung-Muk Leem, Seoul (KR)

Correspondence Address: MAYER, BROWN, ROWE & MAW LLP, 1909 K STREET, N.W., WASHINGTON, DC, 20006, US

(21) Appl. No.: 10/527,846

(22) PCT Filed: Sep. 16, 2002
(86) PCT No.: PCT/KR02/01730

§ 371 Date: Mar. 15, 2005

(51) Int. Cl. H02J 7/35

(52) U.S. Cl. 320/101

(57) ABSTRACT

The present invention relates to a battery pack equipped with a detachable rechargeable battery and a portable electronic device equipped with the battery pack. The battery pack (10) is continuously used by replacing the rechargeable battery (20) rather than replacing an entire battery pack (10) when the life span of the battery pack (10) adopting the charging solar cells (30) expires, and thus, the battery pack (10) must be replaced, and can quickly charge the rechargeable battery (20) through the charging solar cells (30) by preventing the rechargeable battery (20) from being overcharged. The technical construction of the present invention is characterized in that, in a battery pack equipped with a detachable rechargeable battery in which solar light is collected by the solar cells (30) and charges the rechargeable battery (20) to a battery voltage of a certain level, a battery loading hole (16) is formed in one side of a battery housing (12) in a horizontal direction to allow the rechargeable battery (20) to be loaded therein, and the rechargeable battery (20) inserted through the battery loading hole (16) and loaded in the battery housing (12) is fastened by a battery fastener (24), and thus, is connected to power terminals (14) in a contact manner. Additionally, the battery pack (10) is constructed to be integrated with a device body (40), or to be separated from the device body (40).

### TECHNICAL FIELD

The present invention relates, generally, to a battery pack equipped with a detachable rechargeable battery that allows the battery pack with charging solar cells to be continuously used and, more particularly, to a battery pack equipped with a detachable rechargeable battery and a portable electronic device equipped with the battery pack that allow the battery pack to be continuously used by simply replacing a used rechargeable battery rather than replacing an entire used battery pack when the life span of the battery pack adopting charging solar cells expires and, thus, needs to be replaced.

### BACKGROUND ART

As well known, the popularization of portable communication devices due to the rapid development of information and communication technology, together with the Internet revolution, changes the life styles of the modems. In particular, the technology of implementing cellular phones are being remarkably developed, while the technology of implementing a battery pack for operating the cellular phones is slowly developed.

Such a cellular phone automatically recognizes the time to recharge the rechargeable battery through a voltage sensor automatically detecting a reduction in a battery voltage. The battery can be recharged before the battery is completely discharged, or after the battery is compulsorily discharged.

Furthermore, the cellular phone must be miniaturized and lightened to be conveniently carried, so that it is important to reduce the sizes and weights of not only a cellular phone housing, that is, a device body, but also the rechargeable battery, that is, a secondary battery to be charged with electricity from an electrical source.

Accordingly, the rechargeable battery is developed from a nickel cadmium battery to a lithium ion battery through a nickel hydrogen battery to miniaturize and lighten itself. However, the technique of miniaturizing and lightening the rechargeable battery still falls behind for that for the device body. Instead of reductions in the size and capacity of the rechargeable battery, solar cells based on the principle, which is completely different from the principle of implementing the secondary battery to be charged with electricity from the electrical source, is employed as a power supplement means for the rechargeable battery, which charges the battery without the aid of a separate battery charger.

Meanwhile, in the case of the conventional battery pack of a portable electronic device adopting charging solar cells, if the life span of the rechargeable battery in the battery pack expires, and thus, the battery is not longer charged, the used battery pack must be discarded and replaced with a new battery pack. The battery pack adopting the charging solar cells is advantageous in that the inconvenience of charging the rechargeable battery using the battery charger (not shown) can be reduced, but the battery pack cannot extend the life span of itself. As a result, the conventional battery pack cannot overcome the limitation of the life span of the battery pack.

### DISCLOSURE OF THE INVENTION

Accordingly, the present invention is invented to overcome the limitation of the life span of a battery pack adopting charging solar cells occurring in the prior art, and an object of the present invention is to provide a battery pack equipped with a detachable rechargeable battery and a portable electronic device equipped with the battery pack, which allow the battery pack to be continuously used by replacing the rechargeable battery rather than replacing an entire battery pack when the life span of the battery pack adopting the charging solar cells expires, and thus, the battery pack must be replaced, and which can quickly charge the rechargeable battery through the charging solar cells by preventing the rechargeable battery from being overcharged.

In order to accomplish the above object, the present invention provides a battery pack equipped with a detachable rechargeable battery, to which charging solar cells for collecting solar light and charging the rechargeable battery to a battery voltage of a certain level, wherein a battery loading hole is formed in one side of a battery housing in a horizontal direction to allow the rechargeable battery to be loaded therein, and the rechargeable battery inserted through the battery loading hole and loaded in the battery housing is fastened by a battery fastener, and thus, is connected to power terminals in a contact manner.

The rechargeable battery may be integrated with a recharging circuit board, on which a recharging circuit is mounted on one portion of the rechargeable battery, may be inserted into the battery loading hole, and thus, may be connected to the power terminals in a contact manner; or the rechargeable battery may be inserted into the battery loading hole of the battery housing integrated with the recharging circuit board, and thus, may be connected to the power terminals in a contact manner.

A Direct Current (DC) voltage from the charging solar cells may be compared with a reference voltage by a Metal Oxide Semiconductor-Field Effect Transistor (MOS-FET), and the DC voltage corresponds to the battery voltage, the recharging circuit of the recharging circuit board may store and filter the DC voltage through an inductor and a capacitor, rectified the DC voltage into a battery voltage through a rectifying diode, and thus, may quickly charge the rechargeable battery with the DC voltage from the charging solar cells, and when the DC voltage from the charging solar cells is oversupplied, the recharge circuit of the recharging circuit board may quickly charge the rechargeable battery while preventing overcharging using a Pulse-Width-Modulation (PWM) circuit.

The charging solar cells for collecting the solar light may be integrally formed on only an upper surface of the battery housing, or auxiliary solar cells may be additionally provided to be inserted into and drawn from the battery housing in a horizontal direction.

Light collecting projections of the charging solar cells may be formed to be protruded to enlarge a light collection area. In order to accomplish the above object, the present invention provides a portable electronic device adopting a battery pack equipped with a detachable rechargeable battery, wherein a battery loading hole is formed in one side of a battery housing in a horizontal direction to allow the rechargeable battery to be inserted thereinto, and a battery pack, in which the rechargeable battery inserted into the battery housing through the battery loading hole, and thus, loaded in the battery housing is fastened by insertion and combination of a battery fastener, and thus, is connected to power terminals in a contact manner, is mounted on a device body.

The battery pack may be constructed to be integrated with a device body, or to be separated from the device body.

The device body may be a body of a portable communication device.

### BRIEF DESCRIPTION OF THE DRAWINGS

FIG. 1 is a perspective view showing a potable communication device integrated with a rechargeable battery pack equipped with a detachable rechargeable battery, according to the present invention;

FIG. 2 is a perspective view showing the potable communication device separated from the rechargeable battery pack equipped with the detachable rechargeable battery of the present invention;

FIG. 3 is a perspective view showing the rechargeable battery being inserted into the battery loading hole of the battery pack integrated with the potable communication device of the present invention;

FIG. 4 is a perspective view showing the rechargeable battery integrated with a recharging circuit board being inserted into the battery loading hole of the battery pack separated from the potable communication device of the present invention;

FIG. 5 is a perspective view showing the rechargeable battery inserted and seated in the battery loading hole of the battery pack integrated with charging solar cells according to the present invention;

FIG. 6 is a cross-section showing the rechargeable battery inserted and seated in the battery loading hole of the detachable battery pack separated from auxiliary solar cells; and

FIG. 7 is a circuit diagram applied to the battery pack equipped with the detachable rechargeable battery of the present invention.

### *DESCRIPTION OF REFERENCE NUMERALS OF PRINCIPAL ELEMENTS IN THE DRAWINGS*

| | |
|---|---|
| 10: battery pack | 12: battery housing |
| 14: power terminals | 16: battery loading hole |
| 20: rechargeable battery | 22: recharging circuit board |
| 24: battery fastener | 30: charging solar cells |
| 32: PWM circuit | 33: MOS-FET |
| 34: rectifying diode | 35: inductor |
| 36: capacitor | 40: device body |
| 42: auxiliary solar cells | 44: light collecting projections |

### BEST MODE FOR CARRYING OUT THE INVENTION

A battery pack detachably equipped with a rechargeable battery according to preferred embodiments of the present invention is described in detail with reference to the attached drawings below. The battery pack of the present invention is described with reference to a cellular phone, but the present invention can be applied to various portable communication devices, such as a camcorder or a notebook, which require battery packs.

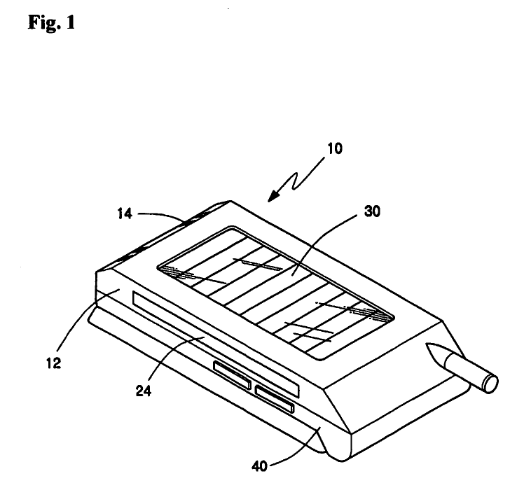

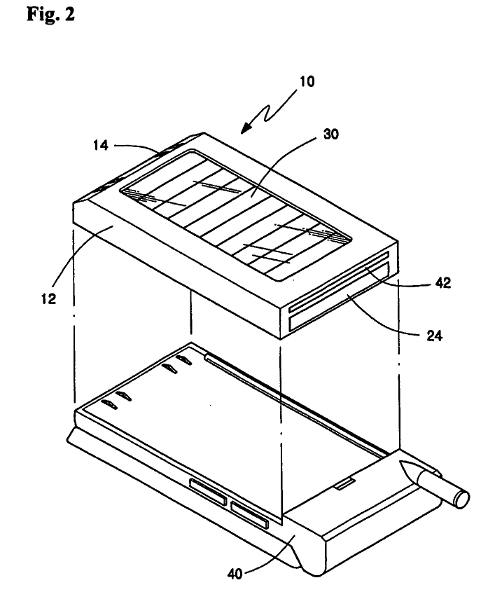

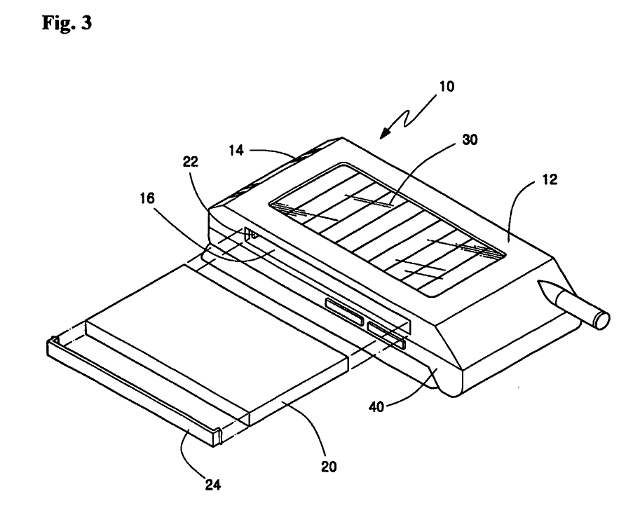

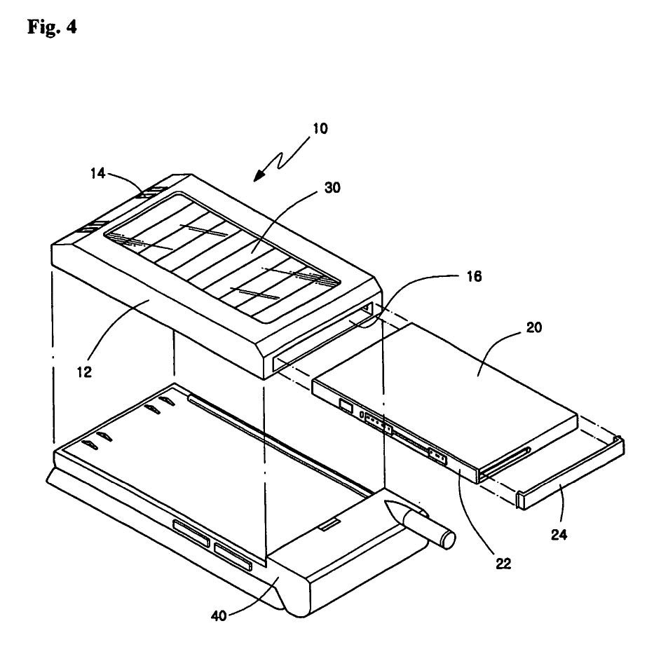

FIG. 1 is view showing a cellular phone that is a portable communication device in which a battery pack 10 detachably equipped with a rechargeable battery is integrated with a device body 40, according to the present invention. FIG. 2 is a view showing a cellular phone in which the battery pack 10 with a detachable rechargeable battery is separated from the device body 40 of the present invention. FIG. 3 is a view showing the rechargeable battery 20 being inserted into the battery loading hole 16 of the battery pack 10 integrated with the device body 40 of the portable communication device of the present invention. FIG. 4 is a view showing the rechargeable battery 20 integrated with a recharging circuit board 22 being inserted into the battery loading hole 16 of the battery pack 10 separated from the device body 40 of the portable communication device of the present invention.

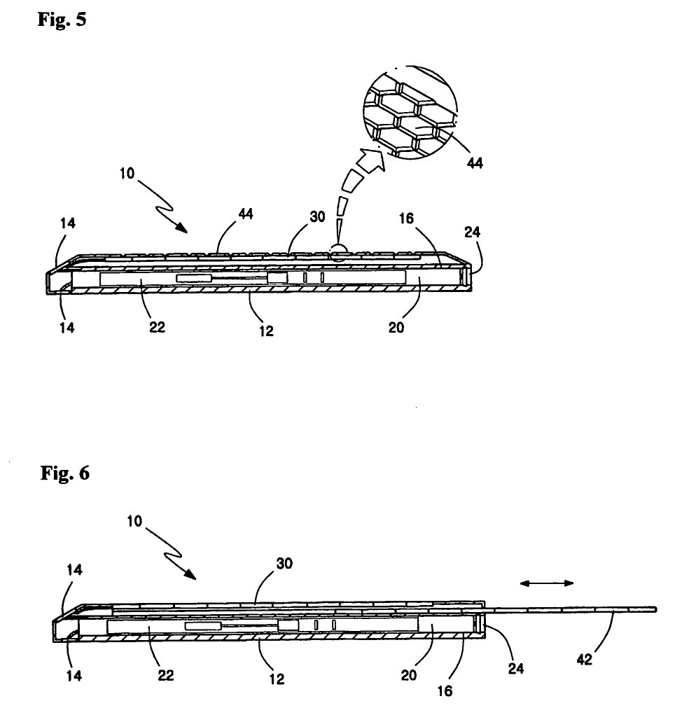

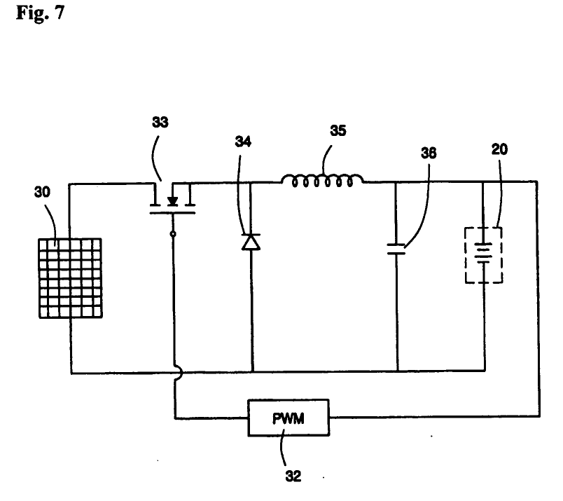

Additionally, FIG. 5 is a cross-section showing the rechargeable battery 20 inserted and seated in the battery loading hole 16 of the battery pack 10 integrated with charging solar cells 20 of the present invention. FIG. 6 is a cross-section showing the rechargeable battery 20 inserted and seated in the battery loading hole 16 of the battery pack 10 separated from detachable auxiliary solar cells 42.

As shown in the drawings, the battery pack 10 adopting the charging solar cells can be continuously used by replacing a used rechargeable battery 20 with a new one rather than replacing an entire battery pack 10 with a new one when the life span of the battery pack 10 adopting the charging solar cells 30 expires, and thus, the battery pack 10 needs to be replaced.

That is, the battery pack 10 of the present invention uses a base structure in which the charging solar cells 30 is integrally attached to an outside of a battery housing 12 of the battery pack 10 to collect solar light through the charging solar cells 30 and charge the rechargeable battery 20 to battery voltage of a certain level even during the moving of the battery pack 10. A battery loading hole 16 is formed in the battery housing 12 in a horizontal direction to allow the user to insert and replace the rechargeable battery 20.

A battery fastener 24 is inserted into one side of a battery housing 12, which is the end of the battery loading hole 16, to fasten the rechargeable battery 20 loaded in the battery loading hole 16. The battery fastener 24 can be formed to be integrated with the one side of the battery housing 12, or to be separated from the battery housing 12. The opening end of the battery loading hole 16 can be selectively formed on the rear and side portions of the battery housing 12 without limitations according to the structure in which the rechargeable battery 20 is integrated with the device body 40 of a portable communication device.

Additionally, like a typical lid structure, locking projections (the reference numeral is omitted) each having a certain inclination are formed on both ends of the battery fastener 24 to be protruded therefrom, and corresponding locking recesses (the reference numeral is omitted) are formed on both ends of the battery loading hole 16, so that the battery fastener 24 is inserted into the battery loading hole 16 of the battery housing 12 with a certain amount of pushing force, and thus, the battery fastener 24 is fastened to the battery loading hole 16. It is preferable that the heights of the battery fastener 24 and battery loading hole 16 are determined to fit the connection part of the device body 40 with which the battery pack 10 is combined.

Power terminals 14 are mounted to extend to the end of the battery loading hole 16 of the battery housing 12 so that both the rechargeable battery 20 inserted and seated in the battery loading hole 16 and the charging solar cells 30 are connected to enable the application of power. Especially, the power terminals 14 to be connected to the rechargeable battery 20 are preferably constructed to be connected to the rechargeable battery 20 in a contact manner when the rechargeable battery 20 is inserted.

Additionally, a recharging circuit board 22 mounted with a recharging circuit is integrally combined with the rechargeable battery 20 in a horizontal direction to quickly charge the rechargeable battery 20 to the battery voltage using the solar light collected by the charging solar cells 30, so that the recharging circuit board 22 of the rechargeable battery 20 loaded in the battery loading hole 16 of the battery housing 12 is constructed to connect to the power terminals 14 of the battery housing 12 in a contact manner.

The rechargeable battery 20 can be constructed to allow the recharging circuit board 22 to be inserted and seated in the battery loading hole 16 of the battery housing 12 so as to allow the power terminals 14 and the recharging circuit board 22 to be applied with power rather than integrating the recharging circuit board 22 having the recharging circuit with the rechargeable battery 20. In this case, the recharging circuit board 22 is attached to one side of the battery loading hole 16 of the battery housing 12 in a horizontal direction, and at least contact terminals 14 are placed on the rechargeable battery 20 to connect with the recharging circuit board 22.

Furthermore, the charging solar cells 30 for collecting solar light is formed only on the upper surface of the battery housing 12 to increase collection efficiency. However, as shown in FIG. 6, auxiliary solar cells 42 are additionally mounted to be inserted into and drawn from a space between the charging solar cells 30 formed on the upper surface and the battery loading hole 16 forming an inside space located under the charging solar cells 30, so that the auxiliary solar cells 42 together with the charging solar cells 30 can enlarge a light collection area. Additionally, bubble-shaped light collecting projections 44, as shown in FIG. 5, are preferably formed to be protruded from the charging solar cells 30 to allow the light collection area to be enlarged.

Meanwhile, the battery pack 10 of the present invention, as shown in the charging circuit diagram of FIGS. 7a to 7c, includes a circuit to quickly charge the rechargeable battery 20 through the charging solar cells 30 by preventing the rechargeable battery 20 from being overcharged. The circuit is formed by connecting a MOS-FET 33 for comparing the DC voltage of the solar light collected through the charging solar cells 30 with a reference voltage of the rechargeable battery 20 required by a cellular phone and switching the direction of supplying a current, and a PWM circuit 32 for protecting the recharging circuit when the DC voltage above the battery voltage is oversupplied from the charging solar cells 30.

Furthermore, to quickly charge the rechargeable battery 20 with a rated voltage after energy storing and filtering when the DC voltage of the charging solar cells 30 compared with the reference voltage by the MOS-FET 33 corresponds to the battery voltage, the recharging circuit is basically formed of an inductor 35 and a capacitor 36 for discharging and charging the applied DC voltage, respectively, and a rectifying diode 34 for rectifying the applied DC voltage into the battery voltage fit for the applied DC voltage of the rechargeable battery.

When the life span of the battery pack 10 adopting the charging solar cells 30 expires, and thus, the rechargeable battery 20 within the battery pack 10 cannot be recharged, the battery pack 10 with the detachable rechargeable battery 20 constructed as described above is handled in such a way that the battery fastener 24 for fixing the rechargeable battery 20 inserted into the battery loading hole 16 of the battery housing 12 is separated from the battery housing 12 and then the used rechargeable battery 20 is removed from the battery housing 12, differently from the conventional battery pack 10 that must be entirely replaced with a new battery pack 10.

When the new rechargeable battery 20 is inserted into the battery loading hole 16 of the battery housing 12, the rechargeable battery 20 is fastened by the battery fastener 24, and thus, the rechargeable battery 20 is connected to the power terminals 14 of the battery housing 12 in a contact manner, the battery pack 10 with the charging solar cells 30 is continuously used by replacing the used rechargeable battery 20 with the new one rather than replacing the entire used battery pack 10 with a new battery pack 10.

Meanwhile, the battery pack 10 with the replaced new rechargeable battery 20 in accordance with the present invention is quickly charged with the DC voltage supplied from the charging solar cells 30 using the recharging circuit mounted on the recharging circuit board 22 while protecting the recharging circuit.

The DC voltage from the charging solar cells 30 is compared with the reference voltage by the MOS-FET 33. If the DC voltage corresponds to the battery voltage, energy storing and filtering are performed by the inductor 35 and the capacitor 36, the DC voltage is rectified into the battery voltage by the rectifying diode 34, and then the rechargeable battery 20 is quickly charged.

When the DC voltage from the charging solar cells 30 is oversupplied, the MOS-FET 33 cuts off the application of the DC voltage to the recharging circuit and applies the DC current to a back circuit 32 so as to prevent the recharging circuit from being overcharged. The DC current stabilized through the back circuit 32 is stored and filtered by the inductor 35 and capacitor 36 of the recharging circuit, and quickly charges the rechargeable battery 20 with the battery voltage through the rectifying diode 34.

Meanwhile, the battery pack 10 with the detachable rechargeable battery 20 according to the present invention can be integrated with a device body 40 of a portable electronic device into a product, or can be separated from the device body 40 into a product. Differently from the conventional battery pack, the battery pack 10 of the present invention can be supplied with power by charging it using solar light collected from the charging solar cells 30, so that the battery pack 10 and the device body 40 do not have to be separated from each other, and thus, the battery pack 10 can have a simple shape.

### INDUSTRIAL APPLICABILITY

As described above, a battery pack equipped with a detachable lithium battery is continuously used by replacing a rechargeable battery 20 rather than replacing an entire battery pack, when the life span of the battery pack adopting charging solar cells 30 expires, and thus, the battery pack needs to be replaced. The rechargeable battery 20 to be charged through the charging solar cells 30 can be quickly charged while protecting from overcharging.

As a result, the battery pack with the charging solar cells can be reused by replacing the rechargeable battery rather than discarding the entire battery pack with the charging solar cells even when the life span of the rechargeable battery expires, so that costs as well as environmental contamination incurred by discarding the battery pack can be reduced. Additionally, since quick charge as well as protection for a recharging circuit are enabled, the convenience of use is increased, so that the battery pack of the present invention is effective when widely used in portable electronic devices requiring battery packs.

1. A battery pack equipped with a detachable rechargeable battery, to which charging solar cells (30) for collecting solar light and charging the rechargeable battery (20) to a battery voltage of a certain level, wherein: a battery loading hole (16) is formed in one side of a battery housing (12) in a horizontal direction to allow the rechargeable battery (20) to be loaded therein; and the rechargeable battery (20) inserted through the battery loading hole (16) and loaded in the battery housing (12) is fastened by a battery fastener (24), and thus, is connected to power terminals (14) in a contact manner.

2. The battery pack as set forth in claim 1, wherein: the rechargeable battery (20) is integrated with a recharging circuit board (22), on which a recharging circuit is mounted on one portion of the rechargeable battery (20), is inserted into the battery loading hole (16), and thus, is connected to the power terminals (14) in a contact manner; or the rechargeable battery (20) is inserted into the battery loading hole (16) of the battery housing (12) integrated with the recharging circuit board (22), and thus, is connected to the power terminals (14) in a contact manner.

3. The battery pack as set forth in claim 1, wherein; when a Direct Current (DC) voltage from the charging solar cells (30) is compared with a reference voltage by a Metal Oxide Semiconductor-Field Effect Transistor (MOS-FET) (33), and the DC voltage corresponds to the battery voltage, the recharging circuit of the recharging circuit board (22) stores and filters the DC voltage through an inductor (35) and a capacitor (36), rectified the DC voltage into a battery voltage through a rectifying diode (34), and thus, quickly charges the rechargeable battery (20) with the DC voltage from the charging solar cells (30); and when the DC voltage from the charging solar cells (30) is oversupplied, the recharge circuit of the recharging circuit board (22) quickly charges the rechargeable battery (20) while preventing overcharging using a Pulse-Width-Modulation (PWM) circuit (32).

4. The battery pack as set forth in claim 1, wherein the charging solar cells (30) for collecting the solar light is integrally formed on only an upper surface of the battery housing (12), or auxiliary solar cells (42) are additionally provided to be inserted into and drawn from the battery housing (12) in a horizontal direction.

5. The battery pack as set forth in claim 1, wherein light collecting projections of the charging solar cells (30) are formed to be protruded to enlarge a light collection area.

6. A portable electronic device adopting a battery pack equipped with a detachable rechargeable battery, wherein: a battery loading hole (16) is formed in one side of a battery housing (12) in a horizontal direction to allow the rechargeable battery (20) to be inserted thereinto; and a battery pack (10), in which the rechargeable battery (20) inserted into the battery housing (12) through the battery loading hole (16), and thus, loaded in the battery housing (12) is fastened by insertion and combination of a battery fastener (24), and thus, is connected to power terminals (14) in a contact manner, is mounted on a device body (40).

7. The portable electronic device as set forth in claim 6, wherein the battery pack (10) is constructed to be integrated with a device body (40), or to be separated from the device body (40).

8. The portable electronic device as set forth in claim 6, wherein the device body (40) is a body of a portable communication device.

9. The battery pack as set forth in claim 4, wherein light collecting projections of the charging solar cells (30) are formed to be protruded to enlarge a light collection area.

10. The portable electronic device as set forth in claim 7, wherein the device body (40) is a body of a portable communication device.
